(19) United States
(12) Patent Application Publication
(10) Pub. No.: US 2017/0290310 A1
(43) Pub. Date: Oct. 12, 2017

(54) Trap Line Fishing Float

(71) Applicant: Go Deep International Inc., Winter Harbor, ME (US)

(72) Inventor: Jacob Knowles, Winter Harbor, ME (US)

(21) Appl. No.: 15/322,280

(22) PCT Filed: Jun. 26, 2015
(86) PCT No.: PCT/US15/38179

§ 371 Date: Dec. 27, 2016

Related U.S. Application Data
(60) Provisional application No. 62/017,938, filed on Jun. 27, 2014.

(51) Int. Cl. A01K 69/06

(52) U.S. Cl. CPC A01K 69/06; A01K 93/00

(57) ABSTRACT

A disk-like fishing float comprises flotation means and attachment means on a bottom section of the float for attachment of a fishing trap line, wherein the bottom section comprises a planing surface for planing of the fishing float on a surface of a water current when the float is held in a water current by the fishing trap line. The float, when attached upstream of a marker buoy attached to the fishing trap line, prevents submerging of the buoy which makes it easier and faster to locate the marker buoy and to haul and set traps. It also reduces the amount of line needed down to the traps thereby reducing costs and the chances of entanglement with trap lines of other fishermen and of harming sea life, and reduces trap rollovers thereby increasing the catch.

This invention concerns a fishing float and a method of using the fishing float in a fishing line, specifically a line of submerged traps for fishing e.g. lobster or crab. More specifically, the invention concerns a fishing float that is configured for use in a fishing trap line set in a water current, such as a tidal or river current.

### BACKGROUND

It is generally important that at least one buoy of a fishing trap line should stay on the surface so the trap line can be efficiently located and hauled. Often, however, when a tidal current is running fast, such as from 3 to 8 knots, trap line buoys are pulled underwater by the force of flowing water on the trap line buoys that are attached to the trap line and, in turn, to traps, such as crab or lobster traps, on the seabed. In order to try to prevent this from occurring, fishermen typically use a lot of excess line, i.e. about 2 feet of line per 1 foot of water depth as measured from the fishing location on the seafloor to the surface. Thus, in a water depth of 300 feet above the first trap (being the closest trap to the line where it first reaches the seabed), a fisherman must use excess line, at least about 600 feet of line (a 2 to 1 ratio of line length to depth of water over the first trap) to try to keep at least one trap line buoy on the surface when the line of traps is set in a tidal current. Such length of line in the water presents a serious physical hazard for sea life and a nuisance to others setting similar trap lines also with excess line. In addition, when the tide is strong enough to pull all trap line buoys (typically there may be 2 or 3) underwater, the first two traps on the seabed are often picked up and rolled over to an upside down position, rendering them unable to catch fish and/or lobsters. Further, when the tide current holds all buoys under the surface, fishermen are either unable to identify them or can only identify them with great difficulty. Further again, buoys held under the surface are not noticeable and often get stuck in propellers, causing damage to lines and traps. Losing traps, in particular, can lead to serious income loss for a fisherman.

In the trap fishing industry, buoys in use typically have elongated cylindrical, bullet, capsule, cube-like, pillar, drop or spherical (round) shapes. None of these buoys of a workable size has sufficient buoyancy to counteract the submerging forces of an increasing tidal current of 3 to 10 knots, or more, acting on a trap line.

If substantially larger or more numerous buoys are used to keep at least one trap line buoy afloat in a current, effectively so that more buoyancy would be thereby provided, this almost always causes rolling over of one or more traps on the seabed (and a rolled over trap will not collect lobster). The increased buoyancy necessary to keep at least one buoy on the surface, also increases lifting pressure on the traps, and a trap lifted off the seabed will typically roll over.

A device and method are plainly needed to make a fishing buoy of a trap line more visible (e.g. to keep it on the surface), to reduce the rolling and turning of traps upside down, to reduce the chance of propeller related damage and loss, and to provide a safer environment for marine life in the vicinity of a trap line set in a strong tidal or river current of from 3 to 10 knots. Still, it is necessary that such device be lightweight for easy, safe use and have a size, shape and cost suitable to fishermen. Such device and method preferably should compensate for the lack of sufficient buoyancy of standard types and numbers of trap line buoys so as to keep at least one of the trap line buoys on the surface of a current.

### SUMMARY OF THE INVENTION

The invention provides a disk-like fishing float comprising flotation means and attachment means on a bottom section of the float for attachment of a fishing trap line, wherein the bottom section comprises a planing surface for planing of the fishing float on a surface of a water current when the float is held in a water current by the fishing trap line.

The bottom section may comprise an annular sloped surface between an annular peripheral area of the planing surface and an annular side edge of the float.

The flotation means may comprise conventional materials, such as a solid waterproof foam (e.g. Styrofoam™), or air encased in a blow molded plastic, resilient shell. Preferably the flotation means at least partly comprises at least one enclosed air cavity inside the float. The at least one air cavity preferably contains compressed air.

Alternatively, the flotation means may comprise a solid waterproof foam such as Styrofoam™.

The annular sloped surface preferably has an inverted frusto-conical shape, and further preferably a slope of from about 30 degrees to about 60 degrees relative to an imaginary plane extending from the planar surface. More preferably such slope is about from 40 degrees to about 50 degrees and most preferably is about 45 degrees relative to the noted imaginary plane. The annular sloped surface may alternatively be convex in vertical cross-section, or any other shape that will function to assist causing planing or skimming of the float in a water current, i.e. so that the water current passes substantially under the bottom section of the float when the float is held in the current by a trap line.

The float may have a planar top surface, optionally fitted for a spindle at the center e.g. optionally providing a flag, handle, or location device.

The annular side edge of the float may have a substantially vertical part relative to the planar section, or it may be a substantially angular edge where an upper edge of the annular sloped surface meets the circumferential edge of the top surface. The float is preferably about from about 1.5 feet to about 4 feet in diameter, more preferably from about 1.75 feet to about 3 feet in diameter, further preferably from about 2 feet to about 3 feet in diameter. The float and is also preferably about from 1.5 inches to about 8 inches, preferably about 2 inches to about 6 inches and most preferably about 2 inches to about 4 inches thick (or height) at a center of the float. A presently preferred configuration is about 2 feet in diameter and from about 2 inches to about 3 inches thick at the center.

In another aspect the invention provides a method of trap fishing in a water current using the above described fishing float, for example when the fishing float is attached to a downstream section of a fishing trap line at a location which is upstream of where at least one fishing buoy is also attached to the downstream section of the fishing trap line. The fishing trap line is attached to one or more fishing traps sitting at a fishing location on a sea or riverbed at an upstream section of the fishing trap line. The length of the fishing trap line from the fishing float to the fishing location on the sea or river bed is less than 2 feet for every 1 foot of water depth at the fishing location, preferably less than about 1.75 feet for every 1 foot of water depth at the fishing location, further preferably between 1.2 and 1.75 feet for every 1 foot of water depth at the fishing location and most preferably between about from 1.2 feet to 1.5 feet for every 1 foot of water depth at the fishing location. The fishing location may be identified as the location of the first trap on the trap line that is closest to where the trap line first reaches the seabed from the surface.

### BRIEF DESCRIPTION OF FIGURES

In the appended Figures that illustrate non-limiting preferred embodiments of the invention:

FIG. 1 displays a perspective view from below of one embodiment of the trap line fishing float of present invention, such being a working prototype;

FIG. 2 displays a side view of the embodiment of FIG. 1;

FIG. 3 displays a top view of the embodiment of FIG. 1;

FIG. 4 displays a bottom view of the embodiment of FIG. 1.

FIGS. 5A and 5B respectively display top and bottom perspective views of another preferred embodiment of the trap line fishing float of the present invention;

FIG. 6A is a picture of the working prototype of FIG. 1 floating in a strong tidal current while attached to a fishing trap line;

FIG. 6B is a picture of a comparative test of another working prototype substantially similar to the prototype of FIG. 1 against known (prior art) fishing buoys and method side-by-side in the same 8 knot current; and

FIG. 7A illustrates a method of the invention using a trap line fishing float according to the invention, whereas FIG. 7B shows a conventional (known) prior art method of trap line fishing.

### DESCRIPTION OF INVENTION

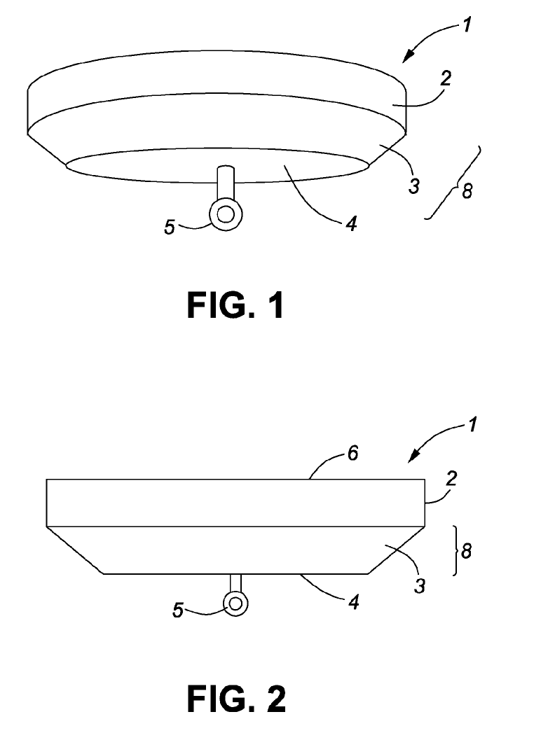

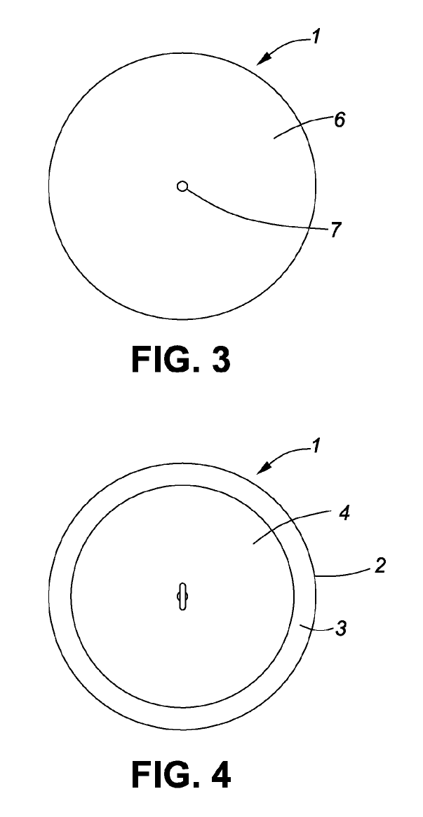

In FIG. 1-FIG. 4 there are displayed several views of one preferred embodiment of the present invention, which is a working prototype that has successfully demonstrated the advantages of the present invention. Briefly, FIG. 1-FIG. 4 show a preferred fishing float 1, according to the invention, which preferably comprises: a side edge surface 2; a bottom section 8 having a planing surface 4, an annular sloped surface 3 and a planar top surface 6. The attachment for a fishing trap line is shown at 5. An optional attachment point for a spindle, or flag to increase visibility, or other location device, is shown at 7 of FIG. 3.

The bottom section 8 slides (skims or planes) easily over the flowing water surface, offering little resistance to the water flow which in turn minimizes the overall impact of the flowing water to the fishing float 1. The fishing float is thus configured to skim or plane over the flowing water surface of the current even in strong currents of 8-10 knots or more. Since there is a minimized impact of the current on the fishing float of the invention, the float is not pushed by the current to the extent that undue strain would be placed in turn on the trap line attached to the float. (This is in contrast to when a conventional trap line buoy on a conventional trap line is in the same current: the force of the water flow of the current pushes the buoy in the direction of the current with sufficient force that the trap line is pulled hard and the buoy is submerged.) With the fishing float of the present invention, there is relatively little force applied to the float by the flowing water even in a strong current, which allows the float to stay substantially in place relative to the fishing location on the seabed without undue strain being applied to the trap line. A consequence of this is that the length of the trap line from the attachment point on the float of the invention down to the first trap in the trap line on the seabed (the first trap being the closest trap to where the trap line first reaches the seabed) can be virtually equal to the depth of water over the first trap (i.e. a length to depth ratio of slightly over 1:1), while the float stays skimming or planing on the surface and the first trap of the fishing trap line stays firmly on the seabed, i.e. without lifting and turning over. Such has been achieved in testing using the prototype of FIGS. 1-4 herein.

The annular sloped surface 3 of the bottom section 8 is a preferred configuration of an annular transition area from an annular peripheral area of the planing surface 4 of the bottom section to the annular perimeter edge 2 of the fishing float 1. The annular transition area and the annular perimeter edge 2 form an annular bow-like feature of the fishing float 1. It is bow-like in that such serves to keep a leading edge (upstream side) of the fishing float 1 above the oncoming water current by preventing or lowering the likelihood of the leading edge from digging beneath the water surface, especially if the oncoming water flow is turbulent (wavy). Since the bow-like feature of the fishing float is preferably uniformly present around the perimeter of the fishing float, the fishing float performs uniformly in the current regardless of any rotation of the fishing float. The fishing float 1 of the present invention is thus designed to prevent the float from running under the water when the tidal current is at its quickest and/or most turbulent condition.

A significant advantage provided by the fishing float of the present invention is that when such is attached to a fishing trap line ahead (upstream) of a conventional trap fishing buoy, also attached to the trap line (e.g. acting as a marker or location buoy at the end of the fishing trap line), the fishing float of the present invention largely prevents any water current-induced pressure or strain on the conventional trap fishing buoy. This will allow the conventional trap fishing buoy to float easily on the surface and fishermen can thereby readily see and gaff the marker buoy with minimal effort. In this manner the fishing trap line attached to the conventional trap fishing buoy may be easily seized for hauling in of the traps.

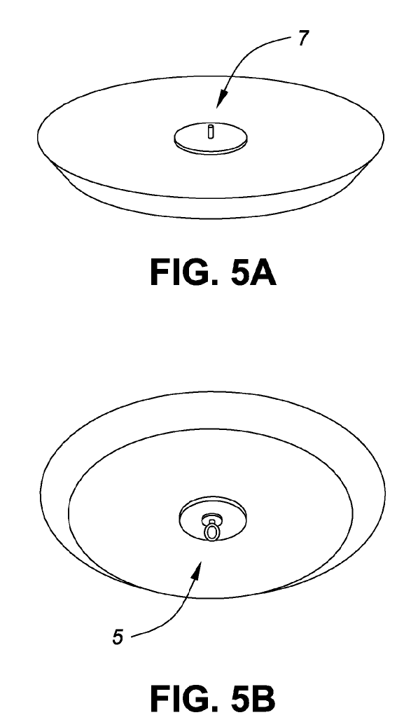

FIG. 2 displays a side view of the preferred embodiment (prototype) of the fishing float of FIG. 1 according to the present invention. The preferred disc-shaped design of the fishing float 1 is readily apparent. The disc-shaped design is also apparent in the further preferred embodiment shown in FIGS. 5A and 5B. In the latter, the side edge of the float is quite angular and the float is not as thick in the middle area, relative to the embodiment of FIG. 1.

FIG. 3 displays an overhead, or top view of the preferred embodiment (prototype) of FIG. 1 of the present invention. This shows a preferred flat, planar top surface 6 of the fishing float 1.

The presently preferred embodiment of the subject invention enables a significant reduction of length of line used in the fishing trap line, thereby for example, helping to prevent aquatic wildlife from becoming entangled in the line. Typically, about 2 feet of line is used for every 1 foot of water over the fishing location on the seabed, however the disc-shaped design enables the present invention to utilize less than about 2 feet, more preferably less than about 1.75 feet, more preferably again between about 1.2 and about 1.75 feet, and most preferably between about 1.5 and 1.75 feet of line per foot of water over the fishing location, thereby reducing the amount of line needed. The present invention therefore requires much less line than in conventional fishing trap lines, making fishing less expensive, making the environment safer for other aquatic life in the vicinity of the fishing, and making it easier to fish around or near other fishermen. Even with less line, the fishing float will largely not run under the water surface of a current, will not lift or roll traps over, and will prevent a conventional trap fishing buoy attached downstream of the inventive fishing float, attached to the same fishing trap line, from pulling under when tidal currents are running thus providing better visibility of the conventional buoy in both day and night fishing.

Preferably the fishing float 1 may be made of a blow molded plastic shell construction having one or more air-tight cavities (not shown) filled with air, or buoyant material such as Styrofoam™ to provide inherent flotation, i.e. to prevent the fishing float from going beneath the surface of still water. Alternatively, the float may comprise a substantially Styrofoam™ construction without a plastic shell. Optionally, a spindle with a reflective flag may be included for increased visibility for nearby boaters.

FIG. 4 displays a bottom view of the preferred embodiment of the present invention. Preferably the fishing float 1 of the invention measures approximately 2 feet in diameter and 2-8 inches in height at the center (excluding the fishing trap line attachment 5), however, the exact size, measurement, construction, and color specifications may vary upon manufacturing considerations. The trap line attachment 5 is preferably located about the middle of the bottom of the fishing float; if located too far forward or too far rearward using a preferred single point of attachment, the fishing float 1 may flop about ineffectively in a tidal or river current. If attached too far forward relative to the current, the leading edge of the float may have a tendency to dig into the water by any downward force or pull on the line attached to the float, whereas if too far aft relative to the current, the float might tip unduly onto its aft edge and be pulled under the surface by the trap line.

The float of the present invention is preferably about from about 1.5 feet to about 4 feet in diameter, more preferably from about 1.75 feet to about 3 feet in diameter, further preferably from about 1.75 feet to about 2 feet in diameter. In a preferred embodiment, the diameter is 21.5 inches and the annular sloped surface is 1.75 inches from its lowest edge adjacent the planing surface 4 to its upper edge adjacent the outer perimeter edge of the upper planar surface 6. Larger diameters than 4 feet are generally too large for comfortable handling by fishermen and unnecessary for achieving satisfactory results in a fast current.

The float according to the invention is also preferably about from 1.5 inches to about 8 inches thick, preferably about 1.75 inches to about 6 inches thick and most preferably about 2 inches to about 4 inches thick (or in height) when measured in a center area of the float. One presently preferred configuration is about 21.5 inches in diameter and 2 inches thick at the center.

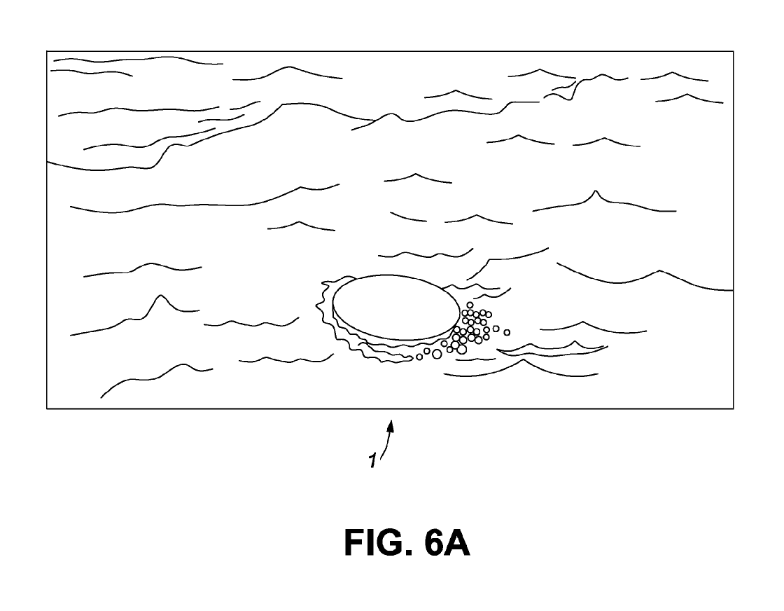

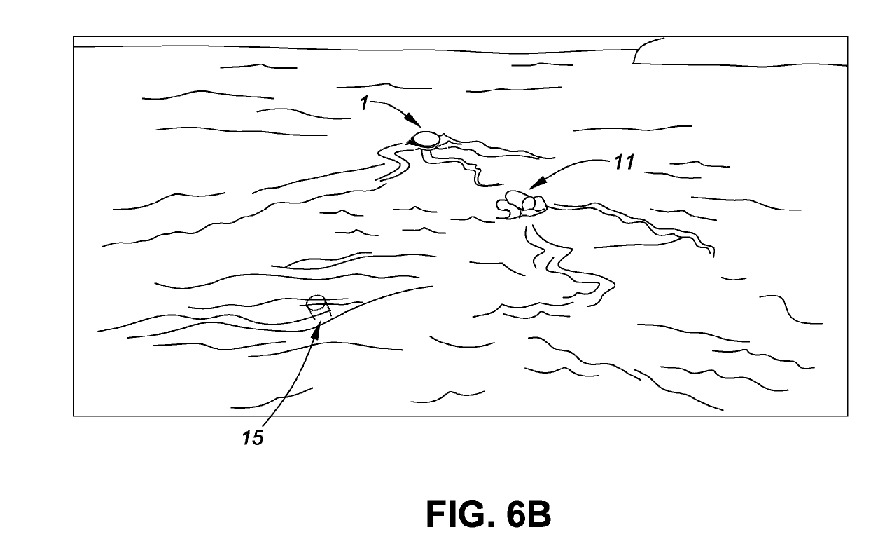

FIG. 6A is an image showing the prototype embodiment of FIG. 1 of the present invention skimming or planing on the surface of a fast moving, turbulent tidal current. This image was obtained from a video recording of the float during a test while it was attached to a trap line upstream of a conventional trap line buoy (not shown), the length of the line being of about 1.2 times the depth of the water over the first trap on the trap line on the seabed.

FIG. 6B is an image showing another prototype according to the invention, substantially similar to the prototype of FIG. 1, in a test, planing in an 8 knot current while attached to a fishing trap line and being located upstream of a conventional fishing trap buoy attached to the end of such fishing trap line. The conventional fishing trap buoy is seen under little strain from the current as it can be seen lying mostly on its side on top of the fast flowing surface. It can easily be seen from a distance and can readily be gaffed, on its slack or lightly tensioned line from the prototype, by a fisherman for hauling in of the trap line. On the left side of the same image can be seen a submerged conventional fishing trap buoy which is the last of two such buoys attached to a different fishing trap line of about the same length as the one to which the prototype according to the invention is attached. As a submerged buoy it will be relatively difficult to see from a distance as well as to be gaffed, if it can even be located, due to its depth in the water and the high strain on the trap line which is to be gaffed. The difficulty in gaffing the line increases the risk of injury to the fisherman as well.

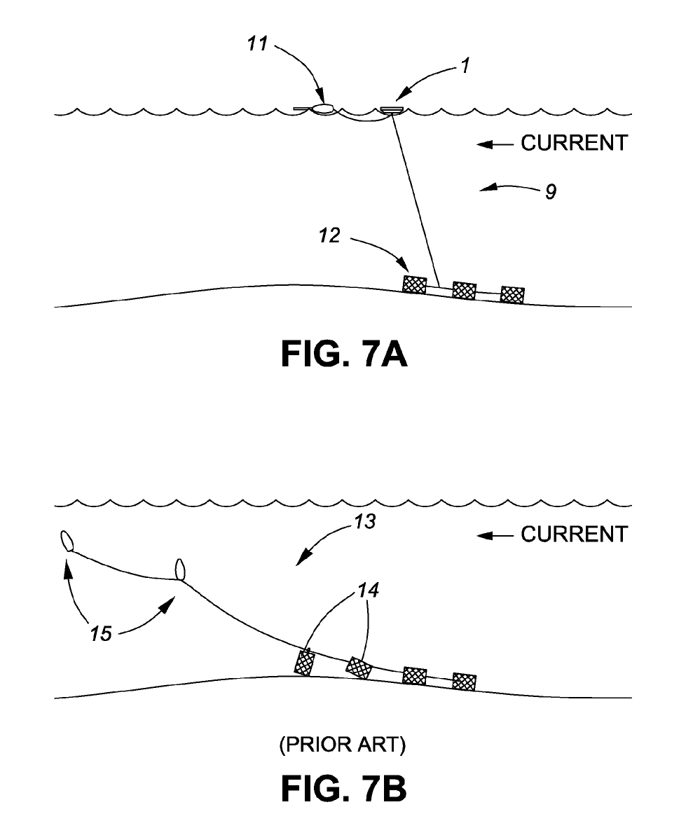

FIG. 7B illustrates at 13 the known prior art method of trap line fishing in a fast water current, which comprises traps on the seabed and buoys at a downstream end of the trap line. The strong current has exerted so much force on the buoys 15 that they have both submerged, and the first two traps 14 have lifted off the seabed and may be inverted. It may be appreciated that if the trap line is substantially extended and the buoys 15 are located further downstream, the buoys may reach the surface, but creating extra hazards and costs as discussed above.

In contrast, FIG. 7A illustrates, at 9, the present inventive method using the inventive fishing float 1 described herein. The fishing float 1 stays on the surface of the water current while being held there by the fishing trap line. The fishing float is skimming or planing over the flowing water (as in FIG. 6A) of the current due to the planing surface 4 of the bottom section of the fishing float. The traps 12 stay on the seabed. The conventional trap fishing buoy 11 is lying on the surface, not submerged, with a slack or lightly tensioned line from it to the fishing float 1 as the inventive fishing float 1 is instead taking most of all of the strain on fishing trap line in the presence of the current while staying on the surface.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiments were chosen and described in order to best explain the principles of the present invention and its practical application, to thereby enable others skilled in the art to best utilize the present invention and various embodiments with various modifications as are suited to the particular use contemplated.

I claim:

1. A disk-like fishing float comprising flotation means and attachment means on a bottom section of the float for attachment of a fishing trap line, wherein the bottom section comprises a planing surface for planing of the fishing float on a surface of a water current when the float is held in a water current by the fishing trap line.

2. The fishing float of claim 1 wherein the bottom section further comprises an annular sloped surface between an annular peripheral area of the planing surface and an annular side edge of the float.

3. The fishing float of claim 1 wherein the flotation means at least partly comprises at least one enclosed air cavity inside the float.

4. The fishing float of claim 3 wherein the at least one air cavity contains compressed air.

5. The fishing float of claim 1 wherein the annular sloped surface has an inverted frusto-conical shape and a slope of from about 30 degrees to about 60 degrees relative to an imaginary plane extending from the planing surface.

6. The fishing float of claim 1 wherein the annular sloped surface is convex in vertical cross-section.

7. The fishing float of claim 1 wherein the float has a planar top surface.

8. The fishing float of claim 1 wherein the planing surface is planar.

9. The fishing float of claim 1 wherein the float is about from 1.5 to about 3 feet in diameter.

10. The fishing float of claim 1 wherein the float is about from 2 inches to about 4 inches in height at a centre of the float.

11. The fishing float of claim 1 wherein the float is made of resilient plastic.

12. A method of trap fishing in a water current using the fishing float according to claim 1, wherein the fishing float is attached to a downstream section of a fishing trap line at a location which is upstream of where at least one fishing buoy is attached to the downstream section of the fishing trap line, the fishing trap line being attached to one or more fishing traps sitting at a fishing location on a sea or river bed at an upstream section of the fishing trap line, wherein the length of the fishing trap line from the fishing float to the fishing location on the sea or river bed is less than 2 feet for every 1 foot of water depth at the fishing location, and wherein the at least one fishing buoy attached to the downstream section of the fishing trap line is kept floating on the water surface during the trap fishing.

13. The method of claim 12 wherein the length of the fishing trap line from the fishing float to the fishing location on the sea or river bed is less than about 1.75 feet for every 1 foot of water depth at the fishing location.

14. The method of claim 12 wherein the length of the fishing trap line from the fishing float to the fishing location on the sea or river bed is between about 1.2 feet and 1.75 feet for every 1 foot of water depth at the fishing location.
